(19) United States
(12) Patent Application Publication
(10) Pub. No.: US 2016/0335252 A1
(43) Pub. Date: Nov. 17, 2016

(54) SYSTEM AND METHOD OF SENTIMENT ACCURACY INDEXING FOR CUSTOMER SERVICE

(71) Applicant: CrowdCare Corporation, Richmond Hill (CA)

(72) Inventors: Jeffrey Brunet, Aurora (CA); Yousuf Chowdhary, Maple (CA); Ian Collins, Markham (CA); Karen Chan, Richmond Hill (CA); David Harold Sanderson, Scarborough (CA)

(21) Appl. No.: 15/152,394

(22) Filed: May 11, 2016

Related U.S. Application Data
(60) Provisional application No. 62/160,046, filed on May 12, 2015.

(51) Int. Cl. G06F 17/27; G10L 25/63; G06F 17/30

(52) U.S. Cl. CPC G06F 17/2785; G06F 17/2705; G06F 17/30699; G06F 17/30616; G10L 25/63

(57) ABSTRACT

A method is provided for evaluating a customer generated communication about a customer device. Terms of a customer generated communication are received with respect to the customer's device. Through a sentiment analysis engine, a sentiment expressed through the customer generated communication is determined. The sentiment has a sentiment strength, positive or negative. Through a parsing engine, an issue is extracted with respect to the device as expressed through the terms of the customer generated communication. A device profile of the device is retrieved, which has device parameters. Relevant device parameters to the extracted issue are determined, and these are forwarded to a rules engine. Through the rules engine, the extent to which the extracted issue is factually justified is verified. The extent of factual justification is correlated with the sentiment strength to arrive at a sentiment accuracy index.

### CROSS REFERENCE TO RELATED APPLICATIONS

This application claims the benefit of U.S. Patent Application No. 62/160,046, filed May 12, 2015, the contents of which are hereby included by reference in their entirety.

### FIELD OF INVENTION

The invention in general relates to customer care for devices and in particular relates to determining the accuracy of a sentiment expressed in a customer generated communication related to a device issue.

### BACKGROUND OF THE INVENTION

Sentiment is an attitude, opinion or feeling toward something, such as a person, organization, product or location. Generally speaking, sentiment analysis aims to determine the attitude of a person with respect to some topic or the overall contextual polarity of a document. The attitude may be a person's judgment or evaluation, affective state, or the intended emotional communication with an organization or a brand.

A basic task in sentiment analysis is classifying the polarity of a given text at the document, sentence, or feature/aspect level—whether the expressed opinion of the writer towards the organization, brand, product or specific feature/aspect of a product/service is positive, negative, or neutral. Alternatively, texts can be given a positive and negative sentiment strength score if the goal is to determine the sentiment in a text rather than the overall polarity and strength of the text.

Existing sentiment analysis algorithms use simple terms to express sentiment about a product or service which are limited, as cultural factors, linguistic nuances and differing contexts make it extremely difficult to turn a string of written text into a simple positive or negative sentiment. In particular, existing sentiment analysis techniques can misunderstand irony and sarcasm, leading to fundamentally skewed or reversed results. In other cases, insufficient detail in the opinion may elude the sentiment analysis engine or may provide no basis for addressing the complaint or comment.

There may be instances where the customer sentiment is justified while others where the sentiment may not be justified. Prior art methods of sentiment analysis do not have the capability to distinguish between these two situations. Thus just knowing the sentiment of a customer communication is not enough to deal with customer care situations.

### SUMMARY OF THE INVENTION

Broadly speaking, the present invention provides a method and a system of sentiment indexing for customer service so that questions, comments and complaints made by customers may be analyzed and their sentiments indexed to ascertain if the sentiment is justified. If the sentiment is justified, then remedial actions may be taken. This allows an organization to reduce churn in customer service and have a more satisfied customer base as a result of having taken preventative measures to mitigate complaints.

Unlike prior art methods of determining the sentiment of text or its units that typically involve a “context-free” or only “very near context” interpretation of the sentiment-laden phrases in an utterance, the present invention acquires and uses contextual information from the device and the OSS/BSS to better understand the accuracy of the sentiment.

The sentiment analysis processes may also use metadata or information about the extralinguistic situation in which an utterance is made. This process may involve using a linguistic analysis done by an NLP system. A “situationally-validated sentiment” may also be derived by comparing the linguistic information gathered via the invention's NLP system and collating it with the information from the mobile device and the information from the operator network.

An app installed on a mobile device may be used by a customer to ask a question or to make a comment or to complain about a product or a service that the organization (e.g. a mobile network operator) provides to the user. In this disclosure customer questions/comments/complaints are also collectively referred to as customer generated communication.

Customer sentiment may be determined from a question/comment/complaint. Sentiment is an attitude, opinion or feeling toward something, such as a person, organization, product or location. Sentiment Analysis is the process of detecting the contextual polarity of text. Sentiment Analysis is used to determine whether a piece of writing is positive, negative or neutral. Generally speaking, sentiment analysis aims to determine the attitude of a person with respect to some topic or the overall contextual polarity of a document. The attitude may be a person's judgment or evaluation, affective state, or the intended emotional communication with an organization or a brand.

An issue may be extracted from the customer question/comment/complaint. When a piece of unstructured text is analyzed using natural language processing, the subsequent concepts are analyzed for an understanding of these words and how they relate to the issue. An issue may be defined as a reason why the user may be complaining or asking a question.

Information may be gathered directly from the mobile device and sent to a remote server. The remote server may be accessible over a network e.g. Internet or LAN (Local Area Network). The server may be a standalone computer that is connected to the internet or other network, or a set of networked computing devices.

Information may also be gathered from the operator OSS/BSS systems regarding the mobile device of the customer, e.g. user account and its history and send it to the remote server. In one embodiment of the invention when gathering information from the various support systems of the operator the customer device ID (e.g. phone number or account number) may be used as the primary key for the query to extract relevant information.

Using Natural Language Processing, an issue may be extracted from the customer question/complaint/comment. The extracted issue may be correlated with the sentiment, information gathered from the device and the information gathered from the network OSS/BSS systems.

Different sets of information related to the extracted issue may be compared; e.g. current state of a variable with historical state of the same variable. For example, a previous month's data usage and long distance calling may be compared with the current month's data usage and long distance calling; or old bills with current bill. If there are large deltas between the past and present information, e.g. present bill is much higher than previous bills, a customer complaint about the current billing may be considered justified.

Customer information may also be compared with the known thresholds for the variable(s) related to the extracted issue. For example a customer's data usage may be compared to the subscription limit of the customer.

Customer information may also be compared with an average network value for the variable(s) related to the extracted issue. For example customer end dropped calls may be compared to the network average of dropped calls.

A feeling/fact gap may be calculated as the divergence between the feelings expressed in the customer generated communication and the facts gathered from the external sources related to the customer's device and account (and with appropriate comparisons as set out above). Thus the larger the divergence between the feelings and the facts, the more likelihood there is that the sentiment expressed is not valid.

This information (events, sentiment) may be transmitted in a digital format to a remote server where the system collates it with the device information and the information from the operator network. The goal of this process may be to measure the feeling/fact gap between the linguistically-expressed sentiment and the technical information that has been gathered from various sources (device, OSS/BSS etc.). In some cases the technical information gathered from the device and the operator network will converge or support the sentiment expressed in the customer generated communications. In other cases the technical information gathered from the device and the operator network and the sentiment may diverge or contradict each other.

A sentiment accuracy index may be created to numerically represent the inverse of this feeling/fact gap. The sentiment accuracy index reflects the veracity of the customer sentiment. Having a better understanding of why the customer generated communication has a negative sentiment, and whether the sentiment is justified, provides a valuable tool when responding to the customers. Where the sentiment accuracy index of a customer generated communication is high, it implies that the customer sentiment is justified, while for situations where sentiment accuracy index is low it implies that the customer sentiment is not justified.

Thus a more efficient system and method of verification and validation of sentiment expressed in customer generated communications is provided by creating a sentiment accuracy index. Devices that can benefit from the system of the invention may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems and any kind of other computing devices. For this invention the benefit is derived from the fact that there are hundreds of parameters and by machine reading the data elements and automatically including a select set of relevant parameters, automated processes for customer service (e.g. automated device fixes or updates), and better targeting for advertisements can also be achieved.

According to a first aspect of the invention, a method is provided for evaluating a customer generated communication about a customer device. Terms of a customer generated communication are received with respect to the customer's device. Through a sentiment analysis engine, a sentiment expressed through the customer generated communication is determined. The sentiment has a sentiment strength, positive or negative. Through a parsing engine, an issue is extracted with respect to the device as expressed through the terms of the customer generated communication. A device profile of the device is retrieved, which has device parameters. Relevant device parameters to the extracted issue are determined, and these are forwarded to a rules engine. Through the rules engine, the extent to which the extracted issue is factually justified is verified. The extent of factual justification is correlated with the sentiment strength to arrive at a sentiment accuracy index.

After the sentiment accuracy index is determined, the issue may be queued for resolution, and/or resolved. In some cases, the sentiment accuracy index may be used for prioritization or triage of resolution of issues. In some cases, an issue may only be queued for resolution if the sentiment accuracy index is above a preset threshold. This may be used to screen out or redirect bogus complaints, “trolls” or communications that are related to something other than a device or service issue.

The parsing step may use a method to standardize and normalize terms, for example, natural language processing. The parsing may be used to particularly identify terms related to device or application functions or services.

Operator information may also be retrieved with respect to the customer's account for a service provided on the device. Relevant operator information may be forwarded with the device parameters to the rules engine for verification of the extent to which the extracted issue is factually justified. The operator information may include at least one of subscription levels or limits, billing, usage patterns, Call Detail Records (CDRs), address, language, other services. The operator information may include current and historical information, in which case the rules engine may be programmed to compare current and historical information to determine any changes. The operator information may include billing or usage information, which is evaluated by the rules engine where the extracted issue is related to billing or charges on the account.

The device parameter may include at least one of make, model, OS, firmware version, apps running or installed, customer country, location, language, service provider, subscription, time zone, connected devices, device crash logs, error logs, or activity logs.

If the extracted issue relates to a service level, the extracted issue may be compared with data or reports from other customers or other devices in the network.

The terms of the customer generated communication may be received as typed text, or as voice input. Speech-to-text and/or text-to-speech functions may also be used to convert one input format into another.

The device profile may be freshly extracted at the time of the customer generated communication. Alternatively, it may be retrieved from a cache of a previous device profile. Old and current device profiles may also be compared.

The method may also include packaging at least the extracted issue of the customer generated communication and the relevant device parameters for resolution by a CSR. For example, this packaging may be done if the sentiment accuracy index is above a preset threshold.

### BRIEF DESCRIPTION OF THE FIGURES

FIG. 1 is a flow diagram illustrating a basic process for sentiment accuracy indexing from a customer generated communication.

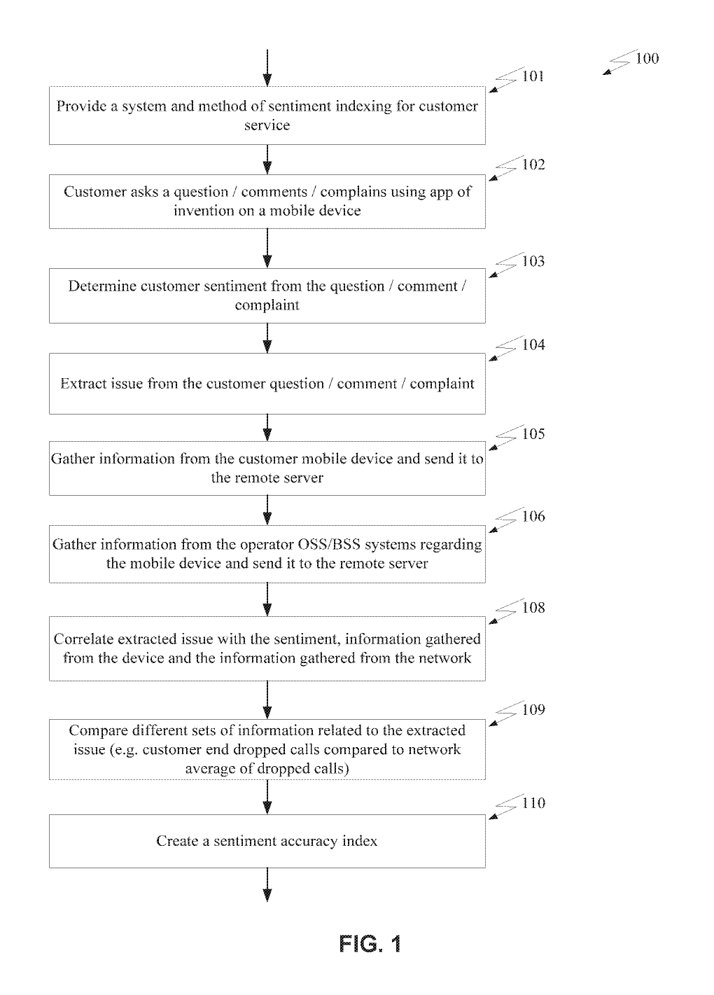

FIG. 2 is a flow diagram illustrating one embodiment of determining sentiment from a customer generated communication.

FIG. 3 is a flow diagram illustrating one embodiment of device analysis for correlation with the customer generated communication.

FIG. 4 is a flow diagram illustrating one embodiment of OSS/BSS data retrieval for correlation with the customer generated communication.

FIG. 5 is a flow diagram illustrating a more comprehensive version of the process in FIG. 1.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements. However, it will be understood that, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or remote computing device or entirely on the remote computer or server or computing device. In the latter scenario, the remote computer may be connected to the mobile device through any type of network, including a local area network (LAN) or a wide area network (WAN), or the connection may be made to the internet through a mobile operator network (e.g. a cellular network). The code is specialized to execute functions described herein which enable a smoother and more efficient technological process.

The system has been developed because the sheer volume of inquiries and communications related to modern devices outstrips all human ability to address each one. In this case, sentiment accuracy indexing is used as an analytical tool that may be implemented to prioritize, triage, or direct certain communications or types of communications for fully-automated handling to avoid/reduce the need for CSR involvement.

A system and method of sentiment indexing is provided for customer service 101. The method and a system of sentiment indexing for customer service allows questions, comments and complaints made by customers to be analyzed and their sentiments indexed to ascertain if their sentiment is justified, and if the sentiment is justified then remedial actions may be taken. This allows an organization to reduce churn and have a more satisfied customer base as a result of having taken preventative measures to mitigate the complaints.

A customer asks a question/comments/complains using an app on a mobile device 102. A specialized app may be installed on a mobile device which is used by a customer to ask a question or to make a comment or to complain about a product or a service that the organization e.g. a mobile network operator may be providing to the said user. In this disclosure customer questions/comments/complaints are also collectively referred to as customer generated communication.

The customer may generate the communication in a text format by typing or using a touch screen interface on a mobile device like a Smartphone. In other embodiments the customer may generate the communications using voice (or vocal commands) and the communication may be converted to text format using Speech to Text technologies. Other embodiments may use other methods of input applicable to the devices where the invention may be implemented.

In one embodiment the functionality of the app may be embedded in another app or software application that is installed on a device. In one embodiment the app of invention may be downloaded from an AppStore.

Customer sentiment is determined from the question/comment/complaint 103.

Sentiment is the attitude, opinion or feeling toward something, such as a person, organization, product or location. Sentiment Analysis is the process of detecting the contextual polarity of text. In other words, it determines whether a piece of writing is positive, negative or neutral. Generally speaking, sentiment analysis aims to determine the attitude of a person with respect to some topic or the overall contextual polarity of a document. The attitude may be a person's judgment or evaluation, affective state, or the intended emotional communication with an organization or a brand.

A basic task in sentiment analysis is classifying the polarity of a given text at the document, sentence, or feature/aspect level—whether the expressed opinion of said person towards the organization, brand, product or a specific feature/aspect of a product/service is positive, negative, or neutral. Alternatively, texts can be given a positive and negative sentiment strength score if the goal is to determine the sentiment in a text rather than the overall polarity and strength of the text.

Existing mechanisms to identify the positive or negative sentiment within a text fail to provide sufficient granularity or insight into the underlying cause of a particular negative sentiment, and in some cases there may not be enough information available in the customer question, comment, or complaint. In the present invention, by gathering and using information from the device and the operator network systems (like OSS/BSS) a much richer context can be acquired to allow for a better understanding of the accuracy of the sentiment expressed by a customer in a customer generated communication.

The method for determining sentiment may use a scaling system whereby words commonly associated with having a negative, neutral or positive sentiment associated with them are assigned numbers on a −5 to +5 scale (where the most negative words are assigned −5 while the most positive words are assigned 50, and neutral words are assigned 0). Other embodiments may use other ranges of numbers e.g. −10 to 10, −3 to 3 etc.

An issue is extracted from the user question/comment/complaint 104. When a piece of unstructured text is analyzed using natural language processing, the subsequent concepts are analyzed for an understanding of these words and how they relate to the issue. An issue may be defined as a reason why the user may be complaining or asking a question e.g. a complaint from a user “Why is my bill so high”; it can be deciphered that the complaint is about an unusually high bill and the customer is unhappy about the situation. Therefore the issue that is extracted from the exemplary customer communications is “bill”.

Information from the customer mobile device is gathered and sent to the remote server 105. The remote server may be accessible over a network e.g. Internet or LAN (Local Area Network). The server may be a standalone computer that is connected to the internet or other network, or a set of networked computing devices.

Device information may be gathered and acquired from the mobile device. Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user, stored WiFi networks, devices paired with a Bluetooth connection, etc. One such app and method for retrieving device profiles is described and taught in U.S. patent application Ser. No. 13/968,631, filed Aug. 16, 2013, which is incorporated herein by reference. Another related system using a device-based approach is described and taught in U.S. patent application Ser. No. 14/256,640, filed Apr. 18, 2014, which is incorporated herein by reference.

The device information may be gathered and sent at the same time as a customer asks a question or complains using the app. In another embodiment the device information may be gathered and sent on demand at a later time after the customer has asked a question or complaint (or may be retrieved from a cached or previous device profile).

Information may be gathered from the operator OSS/BSS systems regarding the customer's mobile device and sent to the remote server 106, e.g. user account and its history. When gathering information from the various support systems of the operator the customer device ID (e.g. phone number or account number) may be used as the primary key for the query to extract relevant information.

OSS (Operational Support Systems or Operations Support Systems) are computer systems (including hardware and software) that are used by telecommunications service providers/operators to manage their networks (e.g., telephone networks). They support management functions such as network inventory, service provisioning, network configuration and fault management.

Business Support Systems are the computer systems (both hardware and software components) that may be used by a telecommunications service provider/operator to run its business operations towards customers. Business Support Systems generally enable four processes: product management, order management, revenue management and customer management. For example BSS enable the taking of orders, resolving payment issues, revenues, etc.

An extracted issue may be correlated with the sentiment, the information gathered from the device and the information gathered from the network (e.g. OSS/BSS systems) 107. Using the example from above, it can be seen that if the issue is “billing” and the sentiment is “negative”, the information from the device that may be relevant e.g. data usage and long distance calling may be extracted, while relevant information from the network may include old and current billing data, usage pattern for data and long distance etc.

The different sets of information related to the extracted issue are compared. For example, the number of dropped calls at the customer end may be compared to the number of average dropped calls across the network 108. Or, the previous month's data usage and long distance calling may be compared with the current month's data usage and long distance calling, or old bills compared with the current bill. If there are large deltas between the past and present information e.g. present bill is much higher than previous bills it can be concluded that the customer complaint is justified.

A sentiment accuracy index may be created 109. The sentiment accuracy index reflects the veracity of the customer sentiment. By having a better understanding of why the customer generated communication has a negative sentiment and whether the sentiment is justified or not provides a valuable tool when responding to the customers. Thus we note that for customer generated communications (questions, complaints, comments) where the sentiment accuracy index is high it implies that the customer sentiment is justified while for situations where sentiment accuracy index is low it implies that the customer sentiment is not justified.

In a first example we examine a customer generated comment that states: “Why is my phone battery draining so fast?”
Sentiment: Negative
Information gathered from the device regarding “Battery Values”:
battery_health_good=Good
battery_status_full=Full
battery capacity=1150 mAh
battery_temperature=20 C
batt_keep_awake_time=5 hours SOT/36 hours standby
Time/Location
Location: Toronto
Time: May 11, 2015

From the above example we see that the sentiment is negative but the battery information gathered from the device suggests that the battery is in good health. Thus we can conclude that the sentiment and device information diverge (i.e. the facts do not support the sentiment) and thus the negative sentiment may not be justified.

In a second example we examine a customer generated comment that states: “My battery just won't charge very well.”
Sentiment=Negative
Information gathered from the device regarding “Battery Values”:
battery_health_cold=Cold
battery_status_not_charging=Not charging
battery capacity=150 mAh
battery_temperature=−30 C
batt_keep_awake_time=0.25 hours SOT/5 hours standby
Time/Location
Location: Alert, Nunavut
Date: Jan. 10, 2015

From the second example we see that the sentiment is negative and the battery information gathered from the device suggests that the battery is in fact not charging properly. Thus we can conclude that the sentiment and device information converge (i.e. the facts support the sentiment) and thus the negative sentiment is justified.

In addition to the device information e.g. device make, model, OS and firmware versions etc., the app may also extract information such as error logs for example logs of certain types of errors, the number of errors in an error log, the severity of errors, the number and frequency of crashes of the device etc.

There may be other sets of information that may be extracted from the device and sent to the server and it will be appreciated that many combinations and subsets are possible. The data received from the mobile device is preferably analyzed using the rules engine. A rules engine is a software system that executes one or more rules in a runtime environment. A rules engine may be viewed as a sophisticated if/then statement interpreter. The if/then statements that are interpreted are called rules. In one embodiment of the invention the app may have the agent and the rules engine embedded in it. In another embodiment the rules engine and the rules may be on a remote server. One such rules engine for customer care is described and taught in U.S. patent application Ser. No. 13/968,631, filed Aug. 16, 2013, which is incorporated herein by reference.

In one embodiment a data package may be created. The data package may contain all or select information gathered by the app on the mobile device and this information may be complemented and supplemented with other information about the consumer and their devices and apps that may have been acquired from other sources like a manufacturer (list of products and services), Google PlayStore or Apple App Store (details of an app and what devices it may control) and the like; information gathered from the OSS/BSS systems and any specific information that may be pertinent to the extracted issue and the sentiment accuracy index.

Some or all relevant information gathered in different steps above may be compiled in a data package and sent as a data package to one or more select third parties like customer care or customer retention teams, who in turn may then opt to use this information when contacting the said customer. Alternatively, the data package may be sent for fully automated handling for specific issues or specific types of communications.

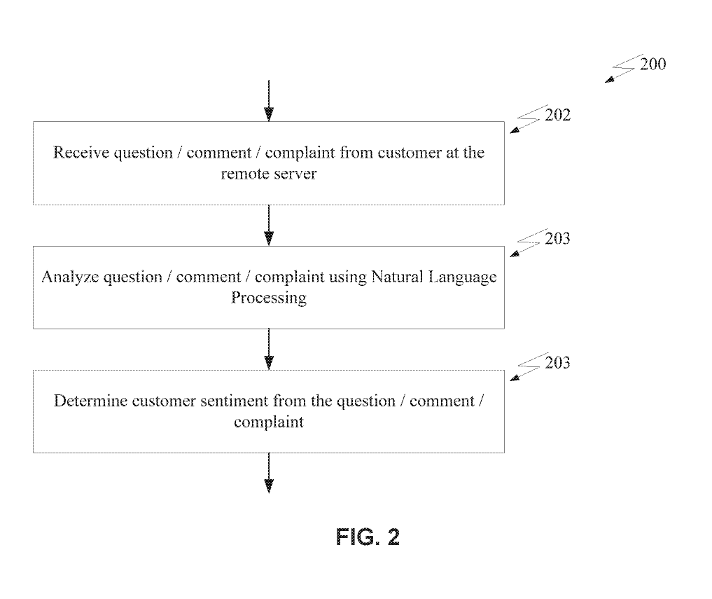

FIG. 2 shows the process of receiving a complaint from a customer and performing sentiment analysis on it 200.

A question/comment/complaint is received from customer at the remote server 201. The customer may send the question/comment/complaint using an app installed on a mobile device e.g. a Smartphone. The remote server may be accessible over a network e.g. Internet or LAN (Local Area Network). The server may be a standalone computer that is connected to the internet or other network or a set of networked computing devices.

The question/comment/complaint may be analyzed using Natural Language Processing 202.

Natural Language Processing (NLP) is a computational method for analyzing the language of electronic texts, interpreting their linguistic content and extracting information from them that is relevant for specific tasks. In one embodiment of the invention, the app's NLP system segments the question/comment/complaint into linguistically significant units (sentences, clauses, phrases, tokens) and determines the semantic significance of these units. The sentiment value of these units is not only determined by their near and long-distance linguistic context but also by the linguistic situation in which the utterances (question/comment/complaint) are being communicated.

Existing methods of determining the sentiment of text or its units typically involve a “context-free” or only “very near context” interpretation of the sentiment-laden phrases in an utterance. Typically only the very near linguistic context is used to interpret the meaning of an expression. A word like “good” is typically assigned an intrinsically positive sentiment value. The sentiment value of this word would typically be adjusted if it were determined that some other element in the very near linguistic context (typically a short span of two or three tokens, or a longer chain of tokens) of “good” adjusts the intrinsic meaning of the word; example, “It is not good” (sentiment=negative). In a sentence where the sentiment is expressed through a longer distance dependency of the linguistic units, sentiment is typically difficult to interpret by computational methods alone; example: “I don't think I could ever honestly say that my phone is very good” (sentiment=negative).

The prior art sentiment analysis processes also typically do not make use of any metadata or information about the extralinguistic context in which an utterance is made. In one embodiment of this invention this will be done using the linguistic analysis done by the NLP system.

In contrast to prior art methods the “situationally-validated sentiment” of one embodiment of the invention is also derived by comparing the linguistic information gathered via the invention's NLP system and collating it with the information from the mobile device and the information from the operator network.

A key part of this process is the linguistic identification of the various events that are referred to in the customer generated communication (question/comment/complaint and the like). The various entities and actions being referred in the text to are identified using a semantic parser. Sentiment-laden expressions are identified and classified according to the classification system shown in Table 1.

Customer sentiment is determined from the question/comment/complaint 203.

One embodiment includes a sentiment engine that is configured to determine the sentiment of customer generated communications. In an embodiment, the sentiment engine executes a set of operations that includes analyzing customer generated question/comment/complaint for sentiment whether the sentiment is negative, neutral or positive and determining the score of this sentiment based on the strength of the sentiment expressed in the user generated communications.

TABLE 1

| Sentiment | Definition | Descriptors | Actions |
|---|---|---|---|
| Strongly | indicates a very strong like | absolutely awesome, the | really love, absolutely |
| Positive | or level of engagement | best ever, crazy good, very | adore, really really like, |
| | | very nice, crazy about, | adore, etc. |
| | | outstanding, etc. | |
| Positive | indicates a milder like or | awesome, good, nice, not so | like, love, accept, etc. |
| | level of engagement | bad, interesting, etc. | |
| Neutral | expresses no obvious | so so, middling, lukewarm, | don't like/don't dislike, |
| | sentiment or shows no | of two minds, ho-hum, | don't love/don't hate, |
| | clear level of engagement; | disinterested, uninteresting, | tolerate, can live with, |
| | may contain mixed | etc. | take or leave, etc. |
| | sentiment message | | |
| Negative | indicates a milder dislike | not nice, not so good, bad, | dislike, avoid, not |
| | or level of disengagement | less than stellar, not so | attracted to, etc. |
| | | outstanding, etc. | |
| Strongly | indicates a very strong | really awful, so shitty, the | absolutely hate, really |
| Negative | dislike or disengagement | worst ever, really really bad, | despise, abhor, detest |
| | | so bad, etc. | |

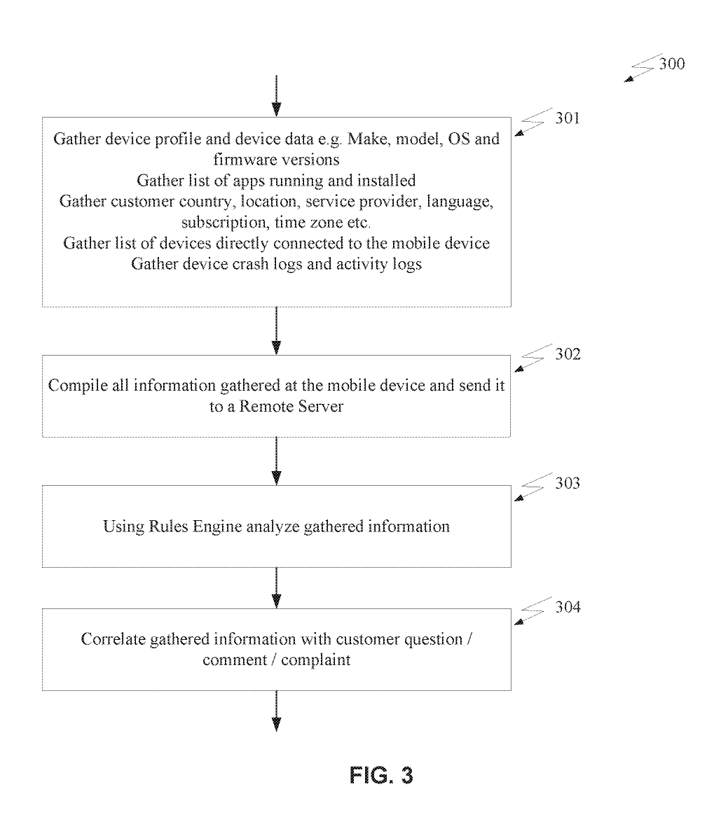

FIG. 3 shows one embodiment 300 depicting the gathering of information from the mobile device 301.

Device information (a device profile) is gathered or acquired from the mobile device. This information may include e.g. make, model, OS and firmware versions; list of apps running and installed; customer country, location, service provider, language, subscription, time zone etc.; list of devices directly connected to the mobile device; device crash logs and activity logs etc.

Information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user, stored WiFi networks, devices paired with a Bluetooth connection, etc.

An exemplary device profile that the app gathers may include the following: device make, device model, OS version, language, operator, location etc.:
Device Make=Motorola
Device Model=Nexus 6
Operating System=Android 5.0.1 Lollipop
Language=English
Operator=AT&T
Location=San Francisco, Calif. USA

In one embodiment the list of apps installed and running on the mobile device may be acquired; e.g. the list of apps installed and running on the mobile device, and may include the following:
Youtube
Fitbit
Google PlayStore
Nest
LG TV Plus
LG TV Remote
Netflix
Starbucks

Additional lists of other devices in the eco-system can also be acquired from the mobile device by analyzing the apps on the device e.g. an app that is a SmartTV remote or other connections e.g. devices that connect directly using a Bluetooth connection.

All information gathered at the mobile device may be compiled and sent to a Remote Server 302.

Using a Rules Engine, the gathered information may be analyzed 303. A rules engine is a software system that executes one or more rules in a runtime environment. A rule engine may be viewed as a sophisticated if/then statement interpreter. The if/then statements that are interpreted are called rules. In one embodiment of the invention the app may have the agent and the rules engine embedded in it while also providing a user interface using which a user may be able to add text e.g. ask a question. In another embodiment of the invention the rules engine and the rules may be on a remote server.

A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific etc.

Gathering information may include but is not limited to capturing the important information from the mobile device, including but not limited to machine read data, delta of parameters, user preferences, user profile, along with the other information that may be deemed useful to the situation.

The app may store the gathered information locally and send it to the remote server as a batch at given intervals e.g. once every night. In another embodiment the app may send the gathered information to the remote server as soon as it is collected.

Gathering information may include but is not limited to capturing the list of Bluetooth devices that connect directly to the mobile device e.g. the audio/video system that may be used to stream music, the list of apps that may be used to control other devices e.g. an app that is a soft remote control for the SmartTV, an app that controls the HVAC system, an app that monitors the security system etc.

Gathering information may also include but is not limited to capturing the list of devices that connect to the mobile device using WiFi e.g. a cable box.

Additionally information may be gathered about what apps that control other devices are installed and running on the mobile device, how often these apps are used to control these devices, the consumer behaviour in terms of when during a day/week/year these apps are used to control devices, the age of the systems being controlled or connected to e.g. knowing when an app for a certain system was installed can provide quite an accurate estimate of the age of the said system. Lookup tables and information about apps and what devices they control may be stored in a database. Such information may also include lists of current and obsolete products and services.

Gathered information may be correlated with the user question/comment/complaint 304. For example if the customer generated communication with a negative sentiment is about an excessively high bill use the device “usage logs” (for example long distance calling, data usage and monthly data allowance as per subscription) to acquire a broader context to the customer utterance. In one embodiment of the invention the correlation between the customer generated communication and the information gathered from the device may be achieved by using a rules engine with rules specifically configured for this purpose.

There may be separate sets of rules for analyzing the information gathered from the device and correlating the gathered information with the customer generated communications. In an alternate embodiment there may a combined set of rules for both analyzing the gathered information and correlating the gathered information with the customer generated communications.

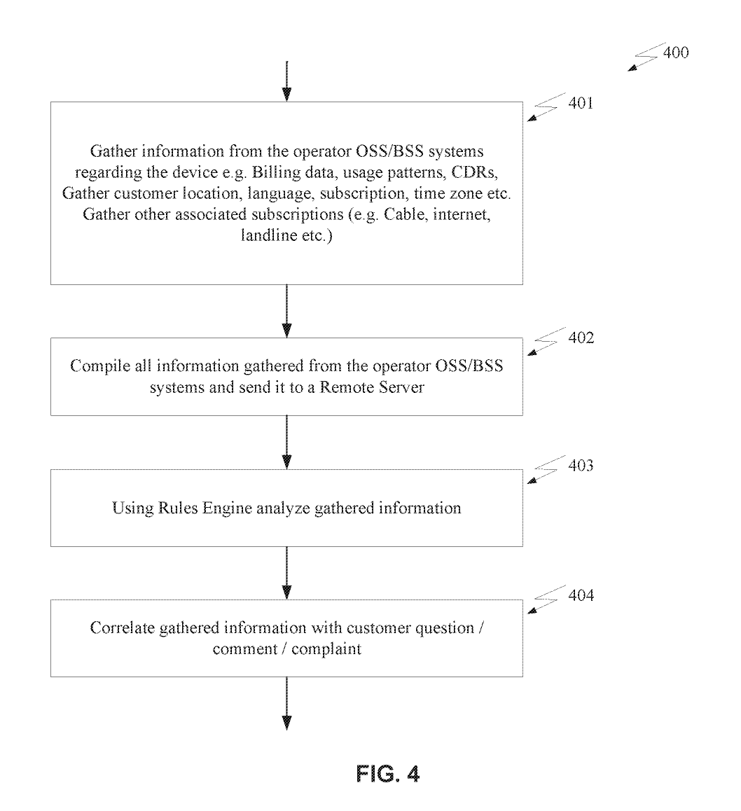

FIG. 4 shows one embodiment 400 depicting the gathering of information from the different OSS/BSS systems of the operator 401.

Information may be gathered from the operator OSS/BSS systems regarding the device e.g. billing data, usage patterns, CDRs; gather customer location, language, subscription, time zone etc.; gather other associated subscriptions (e.g. cable, internet, landline etc.).

All information gathered from the operator OSS/BSS systems may be compiled and sent to a Remote Server 402. Select or all information gathered from the operator OSS/BSS systems may be compiled, e.g. subscription level, customer's previous monthly bills, usage patterns, Call Detail Records (CDRs), address, preferred language, and if the customer also subscribes to any other services provided by the same operator and send it to a Remote Server.

Using Rules Engine, the gathered (select or all) information may be analyzed 403.

This gathered information may be correlated with the customer question/comment/complaint 404.

For example, if the customer generated communication with a negative sentiment is about poor network performance, information about “dropped calls” may be used (for example dropped calls at the user end compared to the average network dropped calls) to acquire a broader context to the customer communication. In one embodiment the correlation between the customer generated communication and the information gathered from the operator network systems may be achieved by using a rules engine with rules specifically configured for this purpose.

There may be separate sets of rules for analyzing the information gathered from the OSS/BSS systems of a network operator and correlating the gathered information with the customer generated communications. In an alternate embodiment a combined set of rules may be used for both analyzing the gathered information and correlating the gathered information with the customer generated communications.

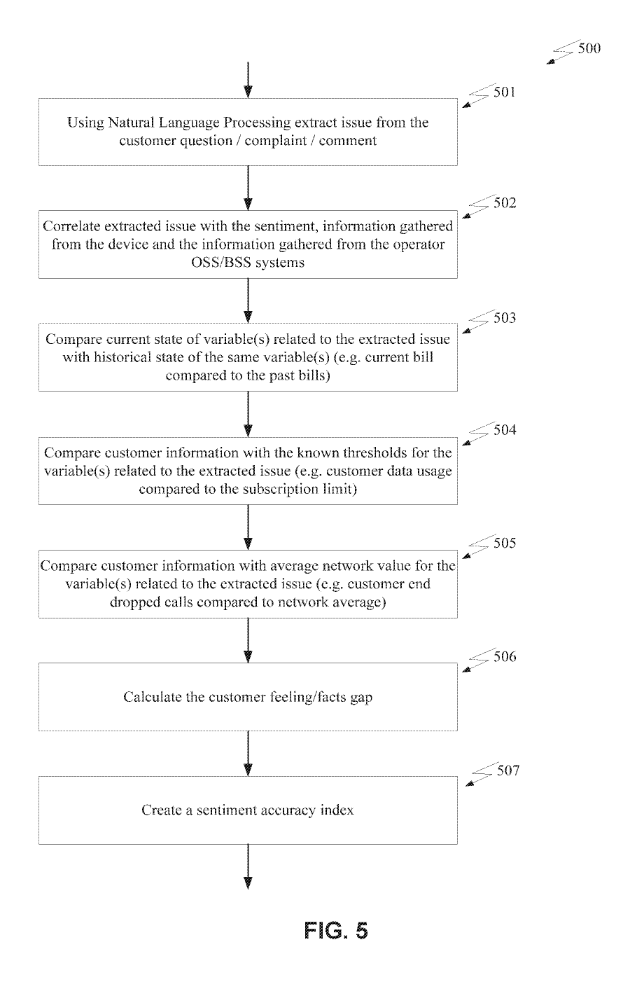

FIG. 5 shows one embodiment 500. Using Natural Language Processing, an issue may be extracted from the customer generated communication (question/complaint/comment) 501.

The extracted issue is correlated with the sentiment, the information gathered from the device and the information gathered from the operator OSS/BSS systems 502.

The current state of variable(s) related to the extracted issue may be compared with historical state of the same variable(s) (e.g. current bill compared to the past bills) 503.

Customer information may be compared with the known thresholds for the variable(s) related to the extracted issue (e.g. customer data usage compared to the subscription limit) 504. As an example the customer subscribes to a 2 GB per month data plan and in the past several months the data usage has been below this threshold, while for the previous month the customer has exceeded this limit and used 3.5 GB of data and in the process incurred a bill that is larger than the previous bills.

User information may be compared with average network value for the variable(s) related to the extracted issue (e.g. customer end dropped calls compared to network average) 505.

The customer feeling/fact gap may be calculated 506. The customer feeling/fact gap can be defined as the divergence between the feelings expressed in the customer generated communication and the facts gathered from the external sources. Thus the larger the divergence between the feelings and the facts, the more likelihood there is that the sentiment expressed is not valid.

In one embodiment this information (events, sentiment) is transmitted in a digital format to the remote server of invention where the system collates it with the device information and the information from the operator network. The goal of this process is to measure the feeling/fact gap between the linguistically-expressed sentiment and the technical information that has been gathered from various sources (device. OSS/BSS etc.). In some cases the technical information gathered from the device and the operator network will converge or support the sentiment expressed in the customer generated communications. In other cases the technical information gathered from the device and the operator network and the sentiment may diverge or contradict each other.

For example, given a customer generated communication like “My phone battery sucks” which has a negative sentiment, the feeling/fact gap will be narrow if the information gathered from the device indicates that the device's battery health is poor. And if the information gathered from the device indicates that the device's battery health is excellent, then the feeling/fact gap will be wider.

The remote server can collates the customer generated communication (question/complaint/comment) with the device information and information from operator network and validate the linguistic sentiment by measuring the customer feeling/fact gap.

A sentiment accuracy index is created 507. A sentiment accuracy index may be created by first validating the linguistic sentiment by measuring the customer feeling/fact gap. One embodiment of the invention uses information external to the customer generated communication to validate if the sentiment expressed in the customer generated communications is based on facts or the sentiment is misplaced.

The sentiment accuracy index may be derived from the customer feeling/fact gap. For example if the customer feeling/fact gap is large/wide that implies that the sentiment is not accurate thus the sentiment accuracy index is low; while when the feeling/fact gap is small/narrow that implies that the sentiment is justified and the sentiment accuracy index is high. Numerically speaking, the sentiment accuracy index may be the inverse of the feeling/fact gap (if expressed as a number).

Therefore when the facts do not support the expressed sentiment it implies that there is a large feeling/fact gap and the sentiment index is low and the sentiment is not accurate. While when the facts support the expressed sentiment it implies that there is a small feeling/fact gap (or no feeling/fact gap) and the sentiment index is high and the sentiment is accurate.

In another example a customer generated communication states: “My wireless carrier is so wonderful”; which on a first pass seems to express a positive sentiment. But a further analysis of information gathered from the device e.g. call logs and the instances of dropped calls and Call Detail Records (CDRs) gathered from the OSS/BSS systems of the operator may show that there are several dropped calls in the past few days. Thus it can be concluded that the comment is sarcastic and there is a real problem perhaps related to an area with poor wireless coverage.

In one embodiment all or relevant information gathered in different steps above may be compiled in one or more data packages in one or more formats containing the information gathered from the mobile device, the operator systems, the extracted issue and the sentiment accuracy index and sent in one or more data packages to select third parties like customer care or customer retention teams; who in turn may then opt to use this information when contacting the said customer.

Creating the data package may include but is not limited to capturing the important information gathered from the device i.e. machine read data, delta of parameters, user preferences, user profile, along with the other information that may be deemed useful to the particular user or the issue.

A data package of gathered information may be matched to one or more entities e.g. a customer service group or a customer retention group. Preferably a there may be a database or list of such entities. The database/list of entities may also preferably contain detailed information for contacting these entities that may be relevant to the devices, their manufacturers, their support groups, their alternatives for escalation etc. In one embodiment of the invention the database of entities or list saved as a file is accessible to other computing devices connecting to the remote server.

The remote server may also have the logic of matching a data package of gathered information about a particular customer with the appropriate entity either within the service provider organization or a group that is outside of the organization, while also preferably having the logic of putting the data package into a format that is acceptable to the matched entity. Exemplary formats for data package may include CSV (Comma Separated Values), XML and JSON but are not limited to these examples. In some cases, the packaging may also include removal of personal information for privacy reasons.

In some embodiments a deadline may be added to the data package so that once the relevant entities receive the data package, particular actions can be taken before the deadline. The deadline is added to the data package to drive the need for urgency. Thus if a customer generated communication is received from a high value account and the sentiment accuracy index is high, the matter may require immediate attention to be resolved in order to retain customer and improve customer satisfaction; prompting a short deadline for customer contact.

Devices that can benefit from the system of the invention may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems. Such devices may also benefit from the fact that there are hundreds of parameters and by machine reading the data elements and automatically including a select set of relevant parameters in a search query ensures increased accuracy.

Although the term app has been used as an example in this disclosure, in essence the term may also apply to any other piece of software code where the embodiments of the invention are incorporated. The software app or application can be implemented in a standalone configuration or in combination with other software programs and is not limited to any particular operating system or programming paradigm described here.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network).

The rules engine of the invention is not necessarily linear when executing the rules. There may be a common starting point when executing the rules, but as the rules get executed and as information gathered from the device and additional information is analyzed, one rule may trigger another rule that may be part of another set of rules. There may also be loops, so that there are rules embedded within rules, or a rule many call another rule as part of its execution. The rule that is called from within the loop or the rule that is called as part of the execution of another rule may not be fixed or static but may depend on the situation and vary as needed.

Several exemplary embodiments/implementations of the invention have been included in this disclosure. The application is not limited to the cited examples, but the intent is to cover all such areas that may be benefit from this invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method for evaluating a customer generated communication about a customer device, comprising:
receiving terms of a customer generated communication with respect to the customer's device;
through a sentiment analysis engine, determining a sentiment expressed through the customer generated communication, the sentiment having a sentiment strength, positive or negative;
through a parsing engine, extracting an issue with respect to the device as expressed through the terms of the customer generated communication;
retrieving a device profile of the device, the profile having device parameters;
determining relevant device parameters to the extracted issue, and forwarding these to a rules engine;
through the rules engine, verifying the extent to which the extracted issue is factually justified; and
correlating the extent of factual justification with the sentiment strength to arrive at a sentiment accuracy index.

2. The method of claim 1, further comprising queuing the issue for resolution.

3. The method of claim 1, further comprising resolving the issue.

4. The method of claim 2, wherein the sentiment accuracy index is used for prioritization of resolution.

5. The method of claim 2, wherein the issue is only queued for resolution if the sentiment accuracy index is above a preset threshold.

6. The method of claim 1, wherein the parsing uses a method to standardize and normalize terms.

7. The method of claim 6, wherein the parsing uses natural language processing.

8. The method of claim 6, wherein the parsing identifies terms related to device or application functions or services.

9. The method of claim 1, further comprising:
retrieving operator information with respect to the customer's account for a service provided on the device.

10. The method of claim 9, wherein relevant operator information is forwarded with the device parameters to the rules engine for verification of the extent to which the extracted issue is factually justified.

11. The method of claim 10, wherein the operator information includes at least one of subscription levels or limits, billing, usage patterns, Call Detail Records (CDRs), address, language, other services.

12. The method of claim 10, wherein the operator information includes current and historical information, and wherein the rules engine is programmed to compare current and historical information to determine any changes.

13. The method of claim 10, wherein the operator information includes billing or usage information, which is evaluated by the rules engine where the extracted issue is related to billing or charges on the account.

14. The method of claim 1, wherein the device parameter includes at least one of make, model, OS, firmware version, apps running or installed, customer country, location, language, service provider, subscription, time zone, connected devices, device crash logs, error logs, or activity logs.

15. The method of claim 10, where the extracted issue relates to a service level, further comprising comparing the extracted issue with data or reports from other customers or other devices in the network.

16. The method of claim 1, wherein the terms of the customer generated communication are received as typed text.

17. The method of claim 1, wherein the terms of the customer generated communication are received as voice input.

18. The method of claim 1, wherein the device profile is freshly extracted at the time of the customer generated communication.

19. The method of claim 1, wherein the device profile is from a cache of a previous device profile.

20. The method of claim 1, further comprising packaging at least the extracted issue of the customer generated communication and the relevant device parameters for resolution by a CSR.

21. The method of claim 20, wherein the packaging is done only if the sentiment accuracy index is above a preset threshold.
